(19) United States
(12) Patent Application Publication
(10) Pub. No.: US 2015/0185845 A1
(43) Pub. Date: Jul. 2, 2015

(54) PROVIDING TACTLE FEEDBACK FOR GESTURE BASED INPUTS

(71) Applicants: Wes A. Nagara, Commerce Township, MI (US); Shadi Mere, Ann Arbor, MI (US); Theodore Charles Wingrove, Plymouth, MI (US); Kyle Entsminger, Canton, MI (US)

(72) Inventors: Wes A. Nagara, Commerce Township, MI (US); Shadi Mere, Ann Arbor, MI (US); Theodore Charles Wingrove, Plymouth, MI (US); Kyle Entsminger, Canton, MI (US)

(21) Appl. No.: 14/558,855

(22) Filed: Dec. 3, 2014

Related U.S. Application Data
(60) Provisional application No. 61/921,001, filed on Dec. 26, 2013.

(51) Int. Cl. G06F 3/01

(52) U.S. Cl. CPC G06F 3/016; G06F 3/017

(57) ABSTRACT

A system and method for providing tactile feedback for a gesture based input is provided herein. The system includes a gesture input receiver to receive an indication from a gesture based input system associated with a specific gesture; a tactile retriever to retrieve a tactile response based on the specific gesture; and a tactile transmitter to transmit the tactile response to a haptic generator, the haptic generator being configured to deliver the tactile response.

### CROSS-REFERENCE TO RELATED APPLICATIONS

This patent application claims priority to U.S. Provisional Application No. 61/921,001, filed Dec. 26, 2013 entitled “Providing Tactile Feedback for Gesture Based Inputs,” now pending. This patent application contains the entire Detailed Description of U.S. Patent Application No. 61/921,001.

### BACKGROUND

Various interfaces and machines employ gesture based inputs. The gesture based inputs allow a detection of movement from a cue, such as a body part (commonly the hand), and based on the detected movement or gesture, a command is initiated. The gesture based inputs do not require the user to make contact with a touch pad or device.

The gesture is captured via a video camera or motion detector. Accordingly, the video camera captures the movement, correlates the movement to a stored command center (i.e. a processor and storage device), and translates the movement into an action.

Gesture based inputs may be implemented in various locations. For example, the gesture based input may be implemented in a vehicle, thereby allowing the driver of the vehicle to safely operate the vehicle while not worrying about making physical contact to an input device.

For example, pointing one's finger in a direction may instigate the vehicle to activate a turn signal. In another instance, waving ones hand back and forth may activate a windshield wiper. In all these instances, the actual correlation between the movement and the command being activated may be programmable and configurable.

### DESCRIPTION OF THE DRAWINGS

The detailed description refers to the following drawings, in which like numerals refer to like items, and in which:

FIG. 1 is a block diagram illustrating an example computer.

FIG. 2 is an example of a system for providing tactile feedback for a gesture based input system.

FIG. 3 is an example of a method for providing tactile feedback for a gesture based input system.

FIGS. 4(a) and 4(b) illustrate an example implementation of system shown in FIG. 2.

FIG. 5 illustrates a lookup table to provide along with an implementation of system shown in FIG. 2.

### SUMMARY

Exemplary embodiments disclosed herein provide a system and method for providing tactile feedback for a gesture based input is provided herein. The system includes a gesture input receiver to receive an indication from a gesture based input system associated with a specific gesture; a tactile retriever to retrieve a tactile response based on the specific gesture; and a tactile transmitter to transmit the tactile response to a haptic generator, the haptic generator being configured to deliver the tactile response.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Gesture based inputs are employed in various situations and contexts. The gesture based input allows for a user or operator to engage with an input or interface without making contact with any surface. The gesture based input is facilitated by a camera or detection technique that allows a gesture to be captured, and a machine or system to be controlled accordingly. The gesture may refer to any portion of a body part that can be controlled and moved. For example, shaking one's hand or pointing a finger may refer to a gesture.

In engaging an interface, users and operators often experience feedback associated with touch and physical contact. Accordingly, user's often times expect a haptic sensation. Haptic technology, or haptics, is a tactile feedback technology which takes advantage of the sense of touch by applying forces, vibrations, or motions to the user.

Accordingly, because gesture based inputs do not have tactile feedback, the feedback often times associated with touch based technologies is missed. Accordingly, a user may be left with an unsatisfying sensation.

Disclosed herein are systems and methods for providing tactile feedback for gesture based inputs. According to the aspects disclosed herein, gesture based input technology is incorporated with tactile feedback technology, thereby allowing a more engaging and satisfying user experience.

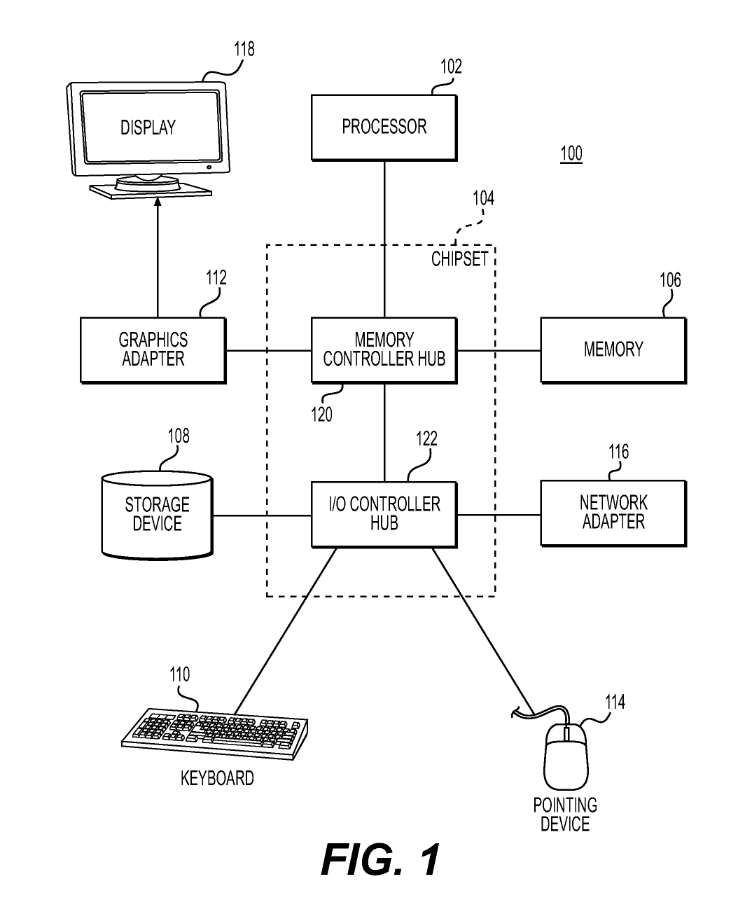

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server.

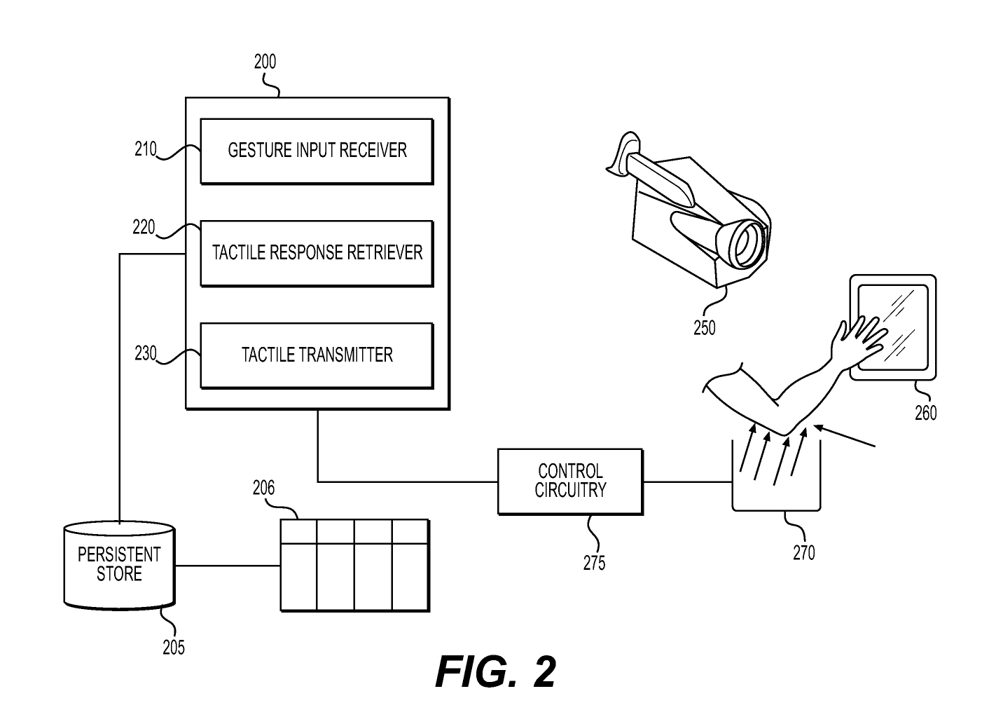

FIG. 2 is an example of a system 200 for providing tactile feedback for a gesture based input system. The system 200 includes a gesture input receiver 210, a tactile retriever 220, and a tactile transmitter 230. The system 200 may be implemented on a device, such as computer 100.

The system 200 may be implemented in any environment or situation where a gesture based input system 250 is employed. For example, the gesture based input system 250 may be situated in a vehicle, and be employed to monitor the gestures made by an operator or passenger of the vehicle. Accordingly, while the operator is driving the vehicle, the operator may make gestures in the gesture detection region 260. Accordingly, the gesture based input system 250 may detect the gesture made in the gesture detection region 260, and transmit a signal or indication to system 200 accordingly.

The gesture input receiver 210 receives the indication from the gesture based input system 250. As shown, the gesture detection region 260 may detect a hand gesture made in the gesture detection region 260. For example, if the hand gesture of an operator or driver of a vehicle indicates that the operator or driver of the vehicle is pointing in a certain direction, the gesture based input system 250 may record this.

The tactile retriever 220 may retrieve, via persistent store 205 (which may be any of the storage devices enumerated above in regards to storage device 108) a corresponding tactile response. The corresponding tactile response may be a physical stimulus associated with the source of the gesture.

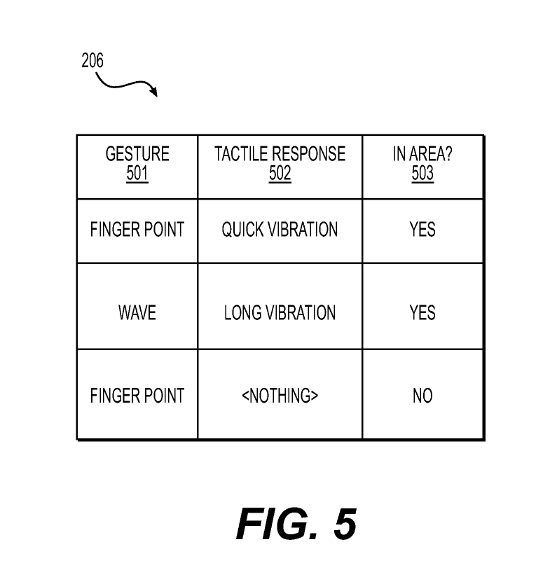

The persistent store 205 may store a lookup table 206. An example implementation of a lookup table 206 is shown in FIG. 5. FIG. 5 illustrates a lookup table 206 to provide along with an implementation of system 200. The lookup table 206 is merely exemplary, and may be provided in different forms, with different combinations or permutations of the fields shown within.

The lookup table 206 includes a gesture field 501, a tactile response 502, and an ‘area?’ field 503. Thus, depending on the detection performed, and whether the detected gesture was within a predefined area, the specific tactile response may be retrieved.

For example, if system 200 is implemented in a vehicle, the physical response may correspond to a vibration or a stimulus on the arm rest area. Accordingly, while the operator of the vehicle is gesturing, a corresponding physical stimulus on an arm rest area may be instigated.

The actual physical response may be configurable by the implementer of system 200. Additionally, a toggle switch or option may be provided to enable and disable this option. The actual physical response and the location of the tactile feedback may also be configurable by the implementer of system 200 or an end user.

The tactile transmitter 230 transmits the tactile response to the appropriate control circuitry 275 associated with replicating the tactile feedback. Accordingly, if the tactile feedback is determined to be a physical vibration in an arm rest location, the tactile transmitter 230 may send a signal to a control circuit that instigates a vibration via the arm rest of the vehicle. The tactile transmitter 230 transmits the signal to the tactile physical area 270. Accordingly, the tactile physical area 270 may replicate the tactile response, and if the end user is abutting the tactile physical area 270, the end user may experience a physical response (such as a vibration or small displacement of the area).

In another example, the tactile physical area 270 may be situated in an area or wearable device to make contact to a wrist or part of a body substantially near the wrist or fingers. The tactile physical area 270 may be situated in other portions of the environment that system 200 is placed in, such as, a seat, upholstery, or any other ergonomic area in which a user's body makes contact with.

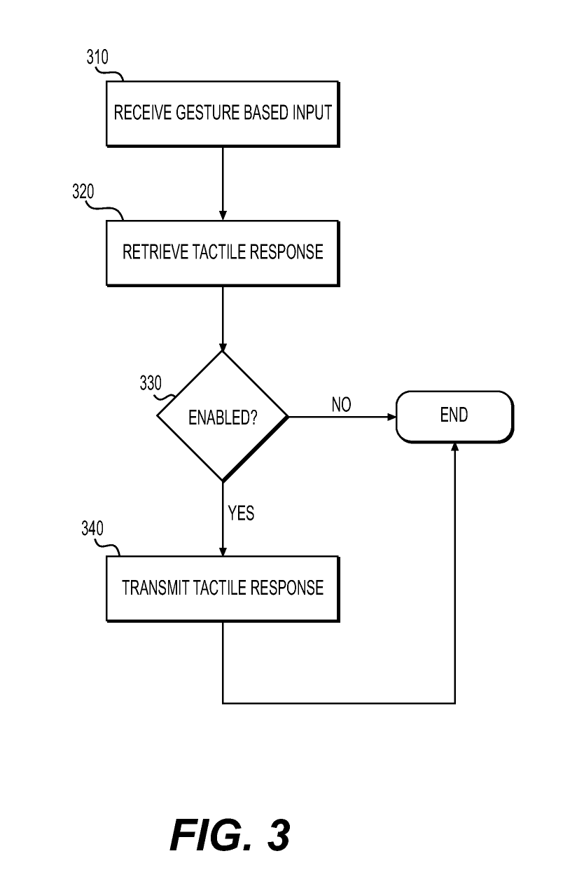

FIG. 3 illustrates a method 300 for providing tactile feedback for a gesture based input system.

In operation 310, a gesture based input signal is received. As explained above, the gesture may correspond to a recorded non-contact control or input signal. The gesture may be recorded via a motion detection device or camera.

In operation 320, the gesture based input signal is correlated to a tactile response. The actual tactile response may be configured selectively based on the location of the tactile response, an end user receiving the tactile response, a predetermined configuration, the gesture instigating the tactile response, or any combinations thereof.

In operation 330, a determination is made as to whether the feature is enabled, and in operation 340, the tactile response is communicated as a command signal to the device instigating the tactile response. Accordingly, a physical area, implemented in the vicinity of a gesture based input area may be employed to generate the tactile response. For example, if the method 300 is implemented in a vehicle, the tactile response may be replicated when a driver of the vehicle's elbows are abutting an arm rest area.

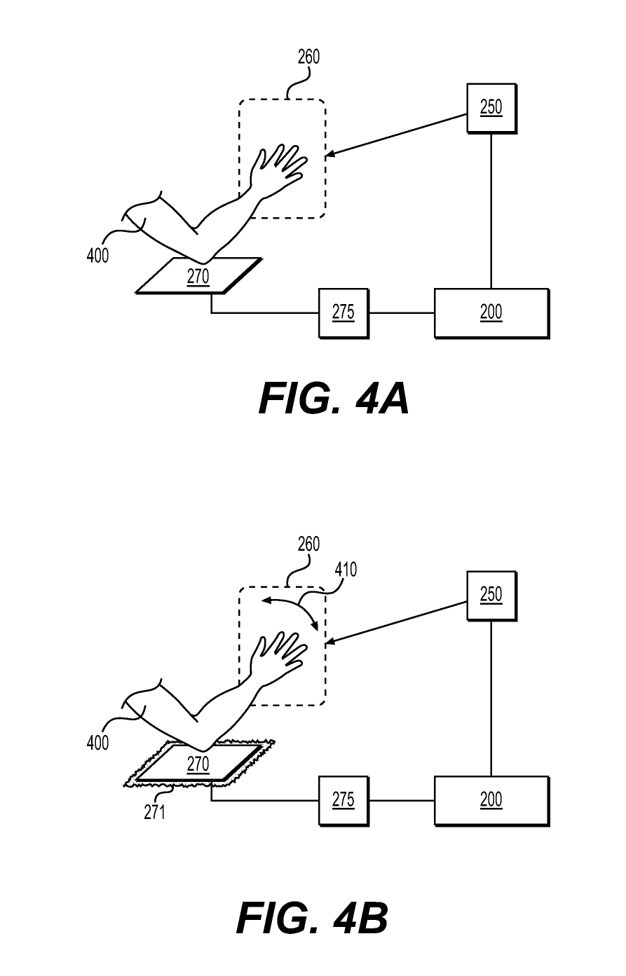

FIGS. 4(a) and (b) illustrate an example implementation of system 200. In FIG. 4(a) an appendage 400 occupies a three-dimensional area 260 associated with a gesture recognition system 250. As shown, the various components communicate (for example, wired or wirelessly) via system 200. System 200 is coupled to a tactile control circuit 275, which is coupled to a haptic generator 270. The appendage 400 rests on the haptic generator 270 (for example, as if the appendage 400 was resting on an arm rest). In another example, the haptic generator 270 may be implemented via a wearable device.

Referring to FIG. 4(b), the appendage 400 is now waving in a manner depicted by motion 410. According to an example associated with the aspects disclosed herein, a tactile response via the haptic generator 270 may be produced. Thus, as shown, the haptic generator 270 may vibrate, as shown by motion lines 271.

Thus, employing the aspects disclosed herein, a non-contact gesture based input system may be fully integrated with physical tactile responses. Accordingly, the end user is provided a more realistic and satisfying user experience.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 3. The disclosed devices, components, and systems contemplate using or implementing any suitable technique for performing the steps illustrated in these figures. Thus, FIG. 3 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for providing tactile feedback for a gesture based input, comprising:
a gesture input receiver to receive an indication from a gesture based input system associated with a specific gesture;
a tactile retriever to retrieve a tactile response based on the specific gesture; and
a tactile transmitter to transmit the tactile response to a haptic generator, the haptic generator being configured to deliver the tactile response.

2. The system according to claim 1, wherein the gesture based input system is implemented in a vehicle.

3. The system according to claim 2, wherein the haptic generator is situated in an arm rest of the vehicle.

4. The system according to claim 1, wherein the gesture input receiver is configured to detect whether the gesture occurs in a predefined area, and the tactile response is based on the gesture occurring in the predefined area.

5. The system according to claim 1, wherein a first tactile response is associated with a first gesture, and a second tactile is response is associated with a second gesture, the first gesture and the second gesture being distinct from one another.

6. The system according to claim 1, wherein the haptic generator is implemented in a wearable device.

7. A method for providing tactile feedback for a gesture based input, comprising:
receiving an indication from a gesture based input system associated with a specific gesture;
retrieving a tactile response based on the specific gesture; and
transmitting the tactile response to a haptic generator, the haptic generator being configured to deliver the tactile response.

8. The method according to claim 7, wherein the gesture based input system is implemented in a vehicle.

9. The method according to claim 7, wherein the haptic generator is situated in an arm rest of the vehicle.

10. The method according to claim 7, wherein receiving further comprises detecting whether a gesture occurs in a predefined area, and retrieving the tactile response based on the detection.

11. The method according to claim 7, wherein a first tactile response is associated with a first gesture, and a second tactile is response is associated with a second gesture, the first gesture and the second gesture being distinct from one another.

12. The method according to claim 7, wherein the haptic generator is implemented in a wearable device.

13. A haptic generator device, comprising:
a receiver for receiving a signal associated with the tactile response; and
a haptic generating mechanism for generating the tactile response, wherein the tactile response is associated with a detection of a gesture based input.

14. The device according to claim 13, wherein the haptic generator device is situated in an armrest of a vehicle.

15. The device according to claim 13, wherein the haptic generator device is situated in a wearable device.
